(19) United States
(12) Patent Application Publication
(10) Pub. No.: US 2016/0015014 A1
(43) Pub. Date: Jan. 21, 2016

(54) System and Method for Making a Red-Eared Slider Turtle Fishing Lure

(71) Applicant: Michael Shawn Smith, Jacksonville, TX (US)

(72) Inventor: Michael Shawn Smith, Jacksonville, TX (US)

(21) Appl. No.: 14/335,023

(22) Filed: Jul. 18, 2014

(51) Int. Cl. A01K 85/18; A01K 83/00

(52) U.S. Cl. CPC A01K 85/18; A01K 83/00

(57) ABSTRACT

The present invention supports a red-eared slider fishing lure designed to provide a user with a red-eared slider fishing lure that resembles the appearance and movement of a turtle hatchling or yearling.

### RELATED APPLICATION DATA

Not Applicable.

### TECHNICAL FIELD

The present invention relates to a system and method for making a red-eared slider turtle fishing lure.

### BACKGROUND OF THE INVENTION

Ancient pre-historic man caught fish for food, and these early fishermen are believed to have used hand lines to catch fish. As early as 2,000 B.C., anglers in China and Egypt were using fishing rods, and the ancient Chinese fishermen are thought to be the first to make fishing line. Of course, that early fishing line is believed to have been made of fine spun silk, rather than the materials more commonly used to make fishing lines today.

Historically, fishing was a popular pastime among the ancient Romans. Back in the third century A.D., Claudius Aelianus wrote extensively about the joys of fly-fishing. He made his own fishing lures out of feathers, bronze and lead, and he made his own fishing line from horsehair.

Throughout most of the history of fishing lures, people have created fishing lures as an individual pastime. Many fishermen enjoyed making their own lures, trying to come up with new and innovative creations that would be more effective in catching fish. Some of these individual craftsmen turned fishing lures into an art form.

In the mid-19th century, the mass production of fishing lures became a commercial venture. By the early 1900s, fishing lures were being mass produced by with Heddon and Pflueger in the Unites States leading the way in the mass manufacture of fishing lures. Many of those early, commercially-made fishing lures were inspired by successful lures made by individual craftsmen.

While fishing lures have been widely available to the public for over a century, many anglers still preferred making their own. In fact, making fishing lures has remained a very popular hobby among fishermen to this day.

Many types and styles of fishing lures have been produced in the past. For instance, plastic worms are among the simplest and most basic of fishing lure. Bass fishermen swear by them, and those fishermen believe artificial worms work better than real worms. Spoon lures are used by Pike fishermen, and spoon lures get their name because they look like the inside of a spoon. This spoon shape causes the lure to dart around in the water and flash in the light. Jigs are weighted hooks that are covered with something that will attract the attention of the fish, like minnows or plastic worms. Many tuna fishermen use feather jigs. And crank baits are fishing lures designed to look and act like a fish's natural food. Generally, such crank baits have a body made of plastic or wood, and several hooks distributed throughout the body. Many fishermen insist these are the best fishing lures for catching walleye fish.

Prior art information regarding fishing lures can be found in: Livingston, A. D. Luremaking: The Art and Science of Spinnerbaits, Buzzbaits, Jigs, and Other Leadheads Camden, Me.: Ragged Mountain Press, 1994; Mayes, Jim. How to Make and Repair Your Own Fishing Tackle: An Illustrated Step-by-Step Guide for the Fisherman and Hobbyist. New York: Dodd, Mead & Company, 1986; Toth, Mike. The Complete Idiot's Guide to Fishing Basics. New York: Alpha Books, 1997; Almy, Gerald. “Golden oldies: 15 tackle-box classics.” Sports Afield (February 1997): 106+; Nichols Lures Inc. http://www.nicholslures.com/ (Jun. 28, 1999); and Ray's Red-eared slider fishing lures. Apr. 15, 1999. http://www.raysfishing.com/ (Jun. 28, 1999).

Red-eared slider turtles get their name from the small red dash of color around their ears. The “slider” part of their name comes from their ability to slide off rocks and logs and into the water quickly. This type of turtle is native primarily to the southern United States and northern Mexico, but red-eared slider turtles are becoming established in other places because of pet releases.

Some states have regulations restricting the possession of red-eared sliders because they can be an invasive species in geographic areas where they are not native. The red-eared slider out competes the native western pond turtle in many introduced areas, such as California. It is illegal in Florida to sell any wild-type red-eared slider, as they interbreed with the local yellow-bellied slider population. Trachemys scripta scripta is another subspecies of pond sliders. Interbred turtles typically combine the markings of the two subspecies. However, unusual color varieties exist for such turtles such as albino and pastel red-eared sliders, which are derived from captive breeding.

Red-eared sliders usually lay their eggs in March and July. Eggs hatch 60 to 90 days after they have been laid. Late-season hatchlings may spend the winter in the nest and emerge when the weather warms in the spring. Hatchlings are roughly 1 inch (2.5 cm) in length. After the first year, a hatchling, now referred to as a yearling, should be around 2-3.5″ inches long.

Once hatchlings and yearlings make their way to a pond, lake or large body of water, they may be consumed by predators including fish, snakes, and alligators. These predators consume small to medium sized (hatchling to yearling) red-eared sliders in massive quantities as part of the larger food chain. It is believed that the red-eared coloration attracts predators toward this food source. Two prior art references show turtle red-eared slider fishing lures, U.S. Pat. No. 6,931,735 and D654,142. These lures show the appeal of using turtle lures, but these references do not disclose the method of making a colored red-eared slider turtle lure which can simulate the appearance and movement of the actual red-eared slider turtle. What is needed is a system and method for making a red-eared slider fishing lure.

### SUMMARY OF THE INVENTION

The present invention supports a system and method for making a red-eared slider turtle lure that replicates red ear slider turtle as bait. The system and method for making such a lure is shown herein, and claimed as part of this invention. Important in the method and system is getting the appropriate shape, coloration, high density construction, and low buoyancy so that the lure most effectively mimics the actual turtle in nature.

### BRIEF DESCRIPTION OF THE DRAWINGS

FIG. 1 is a front perspective view illustrating an embodiment of the red-eared slider fishing lure.

FIG. 2 is a top view illustrating an embodiment of the red-eared slider fishing lure.

FIG. 3 is a bottom view illustrating an embodiment of the red-eared slider fishing lure.

FIG. 4 is a left side view illustrating an embodiment of the red-eared slider fishing lure.

FIG. 5 is a right side view illustrating an embodiment of the red-eared slider fishing lure.

FIG. 6 is a front view illustrating an embodiment of the red-eared slider fishing lure.

FIG. 7 is a back view illustrating an embodiment of the red-eared slider fishing lure.

### DETAILED DESCRIPTION

The present invention is a red-eared slider fishing lure that allows the user to make a red-eared slider fishing lure that resembles the appearance and movement of a turtle hatchling or yearling. Plastic fishing lures, such as fishing worms, are one of the most popular and most productive baits for catching bass and other fish. A lure's size, shape and movements resemble a variety of living creatures, like minnows and crayfish, that bass regularly consume. In the present invention, the red-eared slider fishing lure resembles the size, shape and movements of a red-eared slider turtle.

The red-eared slider fishing lure has a lure body, a front appendage, a left front appendage, a right front appendage, a rear appendage, a left rear appendage and a right rear appendage.

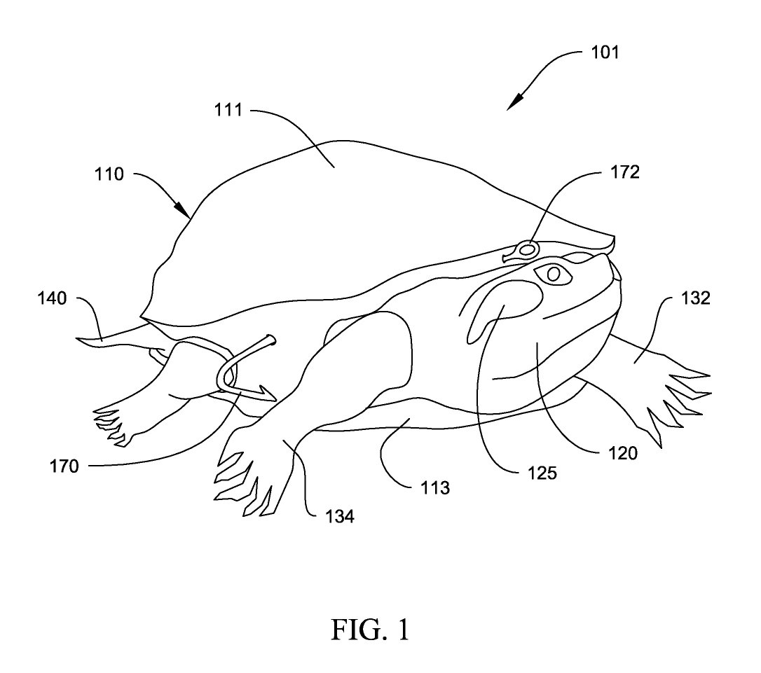

FIG. 1 illustrates a front perspective view of an embodiment of a red-eared slider fishing lure (101). The red-eared slider fishing lure (101) has a lure body (110). The lure body (110) has a top portion (111) that resembles the upper side of a turtle shell, a bottom portion (113) that resembles the lower side of a turtle shell, a front portion, a rear portion, a left side and a right side. In the present invention, the lure has a high density plastic construction and low buoyancy to allow the lure to occupy deep water to bottom of water body areas.

Red-eared slider fishing lure (101) also has a font appendage (120) that resembles the head of a turtle, a left front appendage (132) that resembles the left front leg and foot of a turtle, a right front appendage (134) that resembles the right front leg and foot of a turtle, a rear appendage that resembles the tail of a turtle, a left rear appendage that resembles the left rear leg and foot of a turtle, and a right rear appendage (138) that resembles the right rear leg and foot of a turtle.

One embodiment of the red-eared slider fishing lure (101) has front appendage (120) integral to lure body (110) and extending out from the front portion of the lure body between the left and right sides, left front appendage (132) integral to lure body (110) and extending out from the front portion of the lure body along the left side of the lure body, right front appendage (134) integral to lure body (110) and extending out from the front portion of said lure body along the right side of the lure body, rear appendage integral to lure body (110) and extending out from the rear portion of said lure body between the left and right sides, left rear appendage integral to lure body (110) and extending out from the rear portion of said lure body along the left side of the lure body, and right rear appendage (138) integral to lure body (110) and extending out from the rear portion of said lure body along the right side of the lure body. The appendages are vertically located around the intersection of the top portion (111) and the bottom portion (113) of lure body (110).

Another embodiment of the red-eared slider fishing lure (101) has front appendage (120) secured to said front portion of said lure body between the left and right sides, left front appendage (132) secured to said front portion of said lure body along the left side of the lure body, right front appendage (134) secured to said front portion of said lure body along the right side of the lure body, rear appendage secured to said rear portion of said lure body between the left and right sides, left rear appendage secured to said rear portion of said lure body along the left side of the lure body, and right rear appendage (138) secured to said rear portion of said lure body along the right side of the lure body. The appendages are vertically located around the intersection of the top portion (111) and the bottom portion (113).

Lure body (110) further comprises a hook embedded within. The hook has a hook eye (172), a hook shaft, and a hook barb (170). Hook eye (172) extends out of lure body (110) near the head appendage (120). This location for the hook eye (172) is preferable as it allows the fishing lure to move in a forward motion when the fishing line is pulled. Hook barb (170) extends out of the left side of lure body (110). Preferably the hook barb (170) extends out and then forward as illustrated because the fish will most likely eat the lure from behind, but may extend out and up, down, back or at an angle. Hook barb (170) may also extend out of the right side, top portion, bottom portion, front portion, or back portion of the lure body.

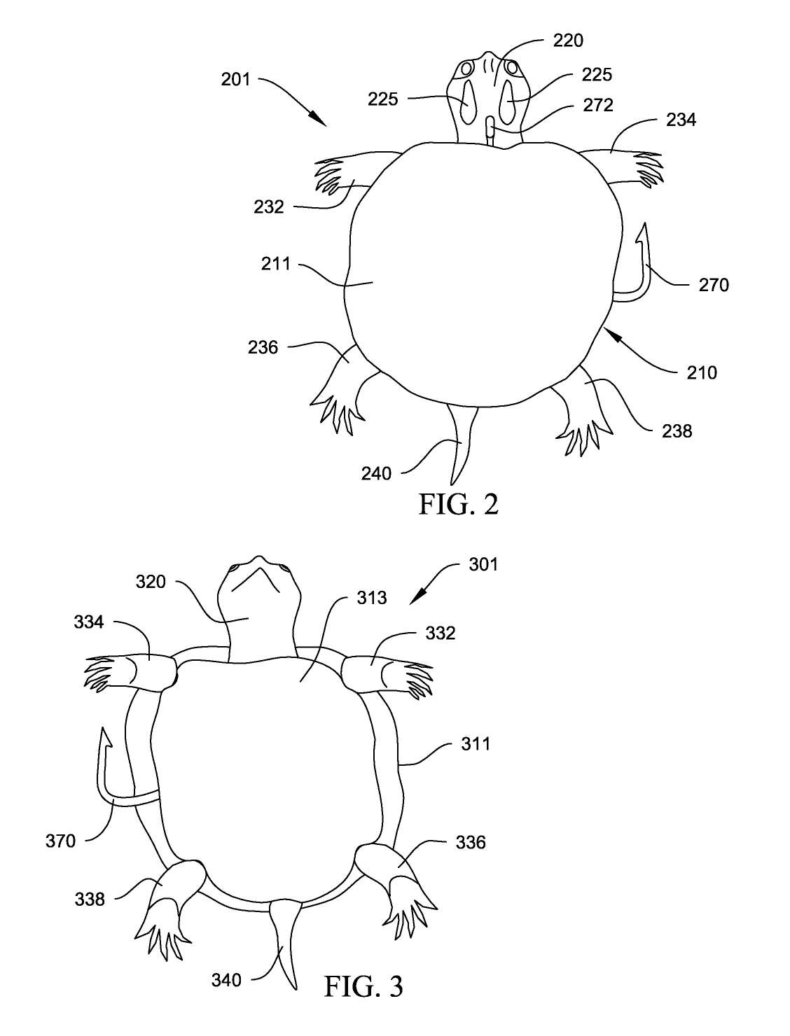

FIG. 2 illustrates a top view illustrating an embodiment of the red-eared slider fishing lure (201). The red-eared slider fishing lure (201) has a lure body (210). The lure body (210) has a top portion (211) that resembles the upper side of a turtle shell, a bottom portion that resembles the lower side of a turtle shell, a front portion, a rear portion, a left side and a right side. In the present invention, the lure has a high density plastic construction and low buoyancy to allow the lure to occupy deep water to bottom of water body areas.

Red-eared slider fishing lure (201) also has a font appendage (220) that resembles the head of a turtle, a left front appendage (232) that resembles the left front leg and foot of a turtle, a right front appendage (234) that resembles the right front leg and foot of a turtle, a rear appendage (240) that resembles the tail of a turtle, a left rear appendage (236) that resembles the left rear leg and foot of a turtle, and a right rear appendage (238) that resembles the right rear leg and foot of a turtle.

One embodiment of the red-eared slider fishing lure (201) has front appendage (220) integral to lure body (210) and extending out from the front portion of the lure body between the left and right sides, left front appendage (232) integral to lure body (210) and extending out from the front portion of the lure body along the left side of the lure body, right front appendage (234) integral to lure body (210) and extending out from the front portion of said lure body along the right side of the lure body, rear appendage (240) integral to lure body (210) and extending out from the rear portion of said lure body between the left and right sides, left rear appendage (236) integral to lure body (210) and extending out from the rear portion of said lure body along the left side of the lure body, and right rear appendage (238) integral to lure body (210) and extending out from the rear portion of said lure body along the right side of the lure body. The appendages are vertically located around the intersection of the top portion (211) and the bottom portion of lure body (210).

Another embodiment of the red-eared slider fishing lure (201) has front appendage (220) secured to said front portion of said lure body between the left and right sides, left front appendage (232) secured to said front portion of said lure body along the left side of the lure body, right front appendage (234) secured to said front portion of said lure body along the right side of the lure body, rear appendage (240) secured to said rear portion of said lure body between the left and right sides, left rear appendage (236) secured to said rear portion of said lure body along the left side of the lure body, and right rear appendage (238) secured to said rear portion of said lure body along the right side of the lure body. The appendages are vertically located around the intersection of the top portion (211) and the bottom portion.

Lure body (210) further comprises a hook embedded within. The hook has a hook eye (272), a hook shaft, and a hook barb (270). Hook eye (272) extends out of lure body (210) near the head appendage (220). This location for the hook eye (272) is preferable as it allows the fishing lure to move in a forward motion when the fishing line is pulled. Hook barb (270) extends out of the left side of lure body (210). Preferably the hook barb (270) extends out and then forward as illustrated because the fish will most likely eat the lure from behind, but may extend out and up, down, back or at an angle. Hook barb (270) may also extend out of the right side, top portion, bottom portion, front portion, or back portion of the lure body.

If anglers use a large plastic worm, such as 10 inches or longer, lures with that large size likely will mean a reduction in bites from smaller bass or smaller fish. When smaller lures are used, such as 3-inch or 4-inch plastic lures, those red-eared slider fishing lures are effective under cold-front or cold-water conditions, and in areas where average bass size is small. Even the largest of bass, however, will bite a small plastic lures, such as the present invention that is sized between 2 to 3.5 inches in length to mimic hatchling to yearling sized red-eared slider turtles.

The present invention is fabricated with a high-density plastic composition that has low level of buoyancy. By sinking to the bottom of a pond or stream, the red-eared slider turtle lure will more accurately mimic the movement and placement of the actual turtles in the body of water. In order to make the present invention, the manufacturer will need, high density liquid plastic, a heat source and heating vessel, a thermometer, coloring, a mold configured to imitate the shape and size of a yearling to hatchling sized red-eared slider turtle. An oil or lubricant will also be useful in preventing the plastic lures from sticking to each other.

The steps in the manufacturing process are as follows. Prior to Step 1, the high density plastic composition should be mixed and combined thoroughly. The high density plastic composition must be thoroughly blended into a homogeneous mixture without separations of the material by settling or other means.

Step 1: Heat approximately 1 oz. to 10 oz. of liquid plastic (high density, low buoyancy plastic composition) in a small vessel over a low heat from 250-350° F. with frequent stirring or agitation. The high density plastic composition is a thermoplastic composition which changes its solidity characteristics with heat, but thermosetting plastic could also be used to set once upon heating and cooling. The high density plastic composition will become clear as it heats. Remove the vessel from the heat source with the plastic composition reaches 325-350° F.

The heat source can be a gas burner, electric heating element, or even a microwave oven. If you choose to heat the high density plastic composition using a stove top or a melting pot, make sure to constantly stir the high density plastic composition to prevent burning. Some heating pots may have an integrated heating element.

One can also use a microwave, but a safety measuring cup or safety glass/porcelain ware to heat the high density plastic composition. If you use a microwave, fill your measuring cup with about ½ cup of mixed liquid plastic. Heat for 1 minute, then stir. Heat for 30 additional seconds and stir again. Repeat until plastic becomes clear and thick (like syrup) Microwaves vary in power, we have found 1-3 minutes is average for this amount of soft plastic.

Step 2: Add coloring mix in the base plastic into the hot high density plastic composition until the plastic has reached your desired shade. Coloring should be highly concentrated pigment and can color up to ½ gallon of plastic when mixed to a proper concentration. Coloring can be added with a dropper at this stage in the processing. For the red-eared slider fishing lure, the base color is a pale to dark green. After molding, the red-eared red patch of coloring placed on either side of the head behind the ear will be added.

Step 3: Pour the colored hot high density plastic composition into a glass measuring cup with a pour spout. This glass container will allow you to easily fill the turtle lure molds without spilling any plastic. Ready the molds for pouring by aligning multiple molds. A mold can possess built-in alignment pins positioned so the mold can only be completely closed in one position. Use all of the C-clips included with your mold to secure the halves of the mold. The number of clips required depends on the size of the mold. Make sure to clip the mold on both sides to prevent leakage.

Molds can be made of modeling clay. Heating of the mold can be accomplished in the oven or other heating device. The mold can be made by setting a block of modeling clay in a warm location long enough for the clay to slightly soften to the point where a soft plastic bait can be pressed into the clay. The red-eared turtle model lure is used to place an impression in the molding clay. One block of clay can be use if the lure will be poured open-faced, and two blocks of clay can be used to make a closed mold.

After the impression is placed in the clay molding material, the mold should be placed in a cool location. Depending on the type of clay you choose, you may only need to let the clay cool and set. Place the block of clay in an oven to bake the clay hard if directed to do so by the manufacturer. Also, a coat of clear sealant should be applied to the clay mold when the mold is set. Thoroughly coat the clay mold with the sealant to help prolong the life of the mold, fill imperfections and help the poured plastic release when it cools.

Step 4: Pour the colored hot high density plastic composition into a red-eared slider turtle mold to fill the molds to the brim. Use vegetable oil to lubricate molds, injector, cups and pans. Plastic baits will to stick in the mold unless the mold is lubricated. To make your baits easy to remove, apply a liberal amount of vegetable oil cooking spray to the mold cavity before shooting.

Soft plastic bait molds are open one piece or two piece molds that produce three dimensional turtle lures and fully formed specialized baits. The molds are virtually unbreakable and feature built-in alignment pins for easy assembly. C-clips are included with each mold to keep the mold closed during filling. The injector is used to force the hot plastic into the mold, and the lure can be injected or combined with a fish attraction fluid or composition. Its reservoir is large enough to make several baits from one filling.

Place the mold on the injector with the nozzle in the smaller injection gate of the mold. This will be in the tail end on the bait. Holding the mold firmly with both hands, apply slow downward pressure until the soft plastic fills the mold and the overflow reservoir at the top of the mold. Two cavity molds need a short cooling period before filling the second cavity. Set the mold aside for a few seconds and fill another mold while you wait for the first cavity to cool.

You should have enough high density plastic to make approximately six to sixty turtle lures. The mold should be formed to allow thin plastic connections between the exterior legs and the body, the exterior head and the body, and the exterior tail and the body. The feet and tail should be non-rigid and thinly constructed to propagate more action as the lure moves through the water. The plastic composition will shrink as it cools, so one needs to make sure the overflow and fill reservoirs of the mold are full to the top when you inject the mold. Under filling the mold can causes hollow bodies.

The liquid high density plastic composition is scorch resistant hot-melt plastic thermoplastic compositions that can be reheated, allowing you to reuse plastic scraps. A hardener can be added to the lure harder, tougher lures. For plastic composition having a body density of 1½ to 2 inches thick, the thickness of the connector between the body and the head/tail/leg should be ¼ to ½ inch thickness. When moved through the water, these connectors will allow the head, legs and tail to move vertically up and down, which will simulate actual movement of the slider turtle in the water. The body and shell thickness of the red-eared slider fishing lure should be approximately 1½ to 2 inches, which allows for a stiff hydrodynamic shape and support the hook placement downward, upward or on the sides of the head or body shell.

Step 5: Allow the lures to cool for one minute in the mold. Move the head out of the mold, without removing the entire lure from the mold. Apply the exterior red coloring to corresponding to the red-eared red patch of coloring placed on either side of the head behind the ear will be added. Coloring can be added with a brush.

Remove the high density plastic lure molds from the injector and stand the mold upright. Allow the soft plastic to cool to a solid consistency. The amount of cooling time will vary based on the size of the bait and number of mold cavities.

Step 6: Allow the high density plastic turtle red-eared slider fishing lures to cool for three to five minutes. Remove the turtles from the molds and place them in cool water until they have cooled completely. Twisting the lure to remove it from the mold can cause the lure to tear or fail. Pull the lure straight out of the mold as soon as the high density plastic composition becomes solid. Let the turtles dry before you store them in plastic bags. Apply a few drops of oil to the plastic turtle lures to prevent them from sticking together in the bag and to keep them from drying out. One should work quickly when the plastic is hot as it will cool quickly and become too thick to pour. Add fluorescent plastic colors to the plastic before it is heated for best results.

The high density plastic material you will use to make soft plastic fishing lures must be heated to about 325-350° F. Spilling or splashing high density hot plastic can cause serious burns to you and your helpers, so it is important to wear safety glasses or a face mask to shield against hot plastic spatters. Moreover, one should wear gloves, leather shoes and long sleeve shirt and pants to protect against burns and spatters. Also, one should never let water or moisture come in contact with heated high density soft plastic because moisture will turn to steam when it contacts hot plastic and cause splattering.

Once made, the red-eared slider turtle lure must be jigged with the proper hook placement, which is downwardly, upwardly or to the sides of the turtle body or turtle head. Multiple hooks can also be hung from various locations on the lure body. Double barbed hooks may also be used.

There are three main plastic rigs that can be used with the turtle lure: Texas rig, Carolina rig and weightless rig. A Texas rig involves threading a bullet-shaped sinker on the line above the hook, then tying the hook to the line. Thread the tip of the turtle lure onto the hook so that the hook point protrudes about ¼ of an inch down the turtle. Then pull the turtle tip up the hook until it is at the top of the hook. Then rotate the hook 180 degrees and impale the hook point into the turtle. The hook point should not protrude through the turtle.

The Carolina rig involves sliding a cone-shaped sinker and one to three beads onto the line, then tying a swivel on the end of the line. A leader should be tied to the other end of the swivel, and a hook tied at the end of the leader. Hook the turtle lure as you would a Texas-rigged turtle lure.

The third rigging option is to use no weight and just use the lure on its own. This is particularly effective in shallow areas, under docks, and around emergent vegetation. The Texas rig is effective around heavy cover, especially in deeper water, while the Carolina rig excels at locating bass scattered on clean bottoms.

When jigged, the turtle lures must be used with the right equipment. Most anglers choose bait casting reels and rods. The reels should be spooled with 10- to 20-lb. line, and the rods should be medium-heavy or heavy action and 6.5 to 7 feet long. Sensitive fishing rods are critical to successful plastic turtle lure fishing, since bass rarely hit a turtle lure hard. Instead, the hit is often little more than a tick, tap or the feeling of something different. It also pays to watch where your line enters the water, since sometimes the only evidence of a hit is your line jumping slightly or moving sideways.

Plastic lures are most often fished on the bottom, but they can also be retrieved through the water so they mimic a bait fish. Some of the most popular methods for rigging them are Texas rigs and on jig heads. Anglers like plastic lures because they can be fished in water of any depth and will attract any size bass that swims.

The present invention can alternatively be fabricated with a low-density plastic composition that has high level of buoyancy. By floating on or near the surface of a pond or stream, the red-eared slider turtle lure will more accurately mimic the movement and placement of the actual turtles in the body of water as if suspended in the water or to resemble a turtle floating up to the surface of the water. In order to make the present invention, the manufacturer will need, low density liquid plastic, a heat source and heating vessel, a thermometer, coloring, a mold configured to imitate the shape and size of a yearling to hatchling sized red-eared slider turtle. An oil or lubricant will also be useful in preventing the plastic lures from sticking to each other.

The steps in the manufacturing process are as follows. Prior to Step 1, the low density plastic composition should be mixed and combined thoroughly. The low density plastic composition must be thoroughly blended into a homogeneous mixture without separations of the material by settling or other means.

Step 1: Heat approximately 1 oz. to 10 oz. of liquid plastic (low density, high buoyancy plastic composition) in a small vessel over a low heat from 250-350° F. with frequent stirring or agitation. The low density plastic composition is a low density thermoplastic composition which changes its solidity characteristics with heat, but low density thermosetting plastic could also be used to set once upon heating and cooling. The low density plastic composition will become clear as it heats. Remove the vessel from the heat source with the plastic composition reaches 325-350° F.

The heat source can be a gas burner, electric heating element, or even a microwave oven. If you choose to heat the low density plastic composition using a stove top or a melting pot, make sure to constantly stir the low density plastic composition to prevent burning. Some heating pots may have an integrated heating element.

One can also use a microwave, but a safety measuring cup or safety glass/porcelain ware to heat the low density plastic composition. If you use a microwave, fill your measuring cup with about ½ cup of mixed liquid plastic. Heat for 1 minute, then stir. Heat for 30 additional seconds and stir again. Repeat until plastic becomes clear and thick (like syrup) Microwaves vary in power, we have found 1-3 minutes is average for this amount of soft plastic.

Step 2: Add coloring mix in the base plastic into the hot low density plastic composition until the plastic has reached your desired shade. Coloring should be highly concentrated pigment and can color up to ½ gallon of plastic when mixed to a proper concentration. Coloring can be added with a dropper at this stage in the processing. For the red-eared slider fishing lure, the base color is a pale to dark green. After molding, the red-eared red patch of coloring placed on either side of the head behind the ear will be added.

Step 3: Pour the colored hot low density plastic composition into a glass measuring cup with a pour spout. This glass container will allow you to easily fill the turtle lure molds without spilling any low density plastic. Ready the molds for pouring by aligning multiple molds. A mold can possess built-in alignment pins positioned so the mold can only be completely closed in one position. Use all of the C-clips included with your mold to secure the halves of the mold. The number of clips required depends on the size of the mold. Make sure to clip the mold on both sides to prevent leakage.

Molds can be made of modeling clay. Heating of the mold can be accomplished in the oven or other heating device. The mold can be made by setting a block of modeling clay in a warm location long enough for the clay to slightly soften to the point where a soft low density plastic bait can be pressed into the clay. The red-eared turtle model lure is used to place an impression in the molding clay. One block of clay can be used if the lure will be poured open-faced, and two blocks of clay can be used to make a closed mold.

After the impression is placed in the clay molding material, the mold should be placed in a cool location. Depending on the type of clay you choose, you may only need to let the clay cool and set. Place the block of clay in an oven to bake the clay hard if directed to do so by the manufacturer. Also, a coat of clear sealant should be applied to the clay mold when the mold is set. Thoroughly coat the clay mold with the sealant to help prolong the life of the mold, fill imperfections and help the poured plastic release when it cools.

Step 4: Pour the colored hot low density plastic composition into a red-eared slider turtle mold to fill the molds to the brim. Use vegetable oil to lubricate molds, injector, cups and pans. Plastic baits will to stick in the mold unless the mold is lubricated. To make your baits easy to remove, apply a liberal amount of vegetable oil cooking spray to the mold cavity before shooting.

Soft plastic bait molds are open one piece or two piece molds that produce three dimensional turtle lures and fully formed specialized baits. The molds are virtually unbreakable and feature built-in alignment pins for easy assembly. C-clips are included with each mold to keep the mold closed during filling. The injector is used to force the hot plastic into the mold, and the lure can be injected or combined with a fish attraction fluid or composition. Its reservoir is large enough to make several baits from one filling.

Place the mold on the injector with the nozzle in the smaller injection gate of the mold. This will be in the tail end on the bait. Holding the mold firmly with both hands, apply slow downward pressure until the soft plastic fills the mold and the overflow reservoir at the top of the mold. Two cavity molds need a short cooling period before filling the second cavity. Set the mold aside for a few seconds and fill another mold while you wait for the first cavity to cool.

You should have enough plastic to make approximately six to sixty turtle lures. The mold should be formed to allow thin plastic connections between the exterior legs and the body, the exterior head and the body, and the exterior tail and the body. The feet and tail should be non-rigid and thinly constructed to propagate more action as the lure moves through the water. The low density plastic composition will shrink as it cools, so one needs to make sure the overflow and fill reservoirs of the mold are full to the top when you inject the mold. Under filling the mold can causes hollow bodies.

The liquid plastic composition is scorch resistant low density hot-melt plastic thermoplastic compositions that can be reheated, allowing you to reuse plastic scraps. A hardener can be added to the lure harder, tougher lures. For low density plastic composition having a body density of 1½ to 2 inches thick, the thickness of the connector between the body and the head/tail/leg should be ¼ to ½ inch thickness. When moved through the water, these connectors will allow the head, legs and tail to move vertically up and down, which will simulate actual movement of the slider turtle in the water. The body and shell thickness of the red-eared slider fishing lure should be approximately 1½ to 2 inches, which allows for a stiff hydrodynamic shape and support the hook placement downward, upward or on the sides of the head or body shell.

Step 5: Allow the lures to cool for one minute in the mold. Move the head out of the mold, without removing the entire lure from the mold. Apply the exterior red coloring to corresponding to the red-eared red patch of coloring placed on either side of the head behind the ear will be added. Coloring can be added with a brush.

Remove the mold from the injector and stand the mold upright. Allow the low density soft plastic to cool to a solid consistency. The amount of cooling time will vary based on the size of the bait and number of mold cavities.

Step 6: Allow the low density turtle red-eared slider fishing lures to cool for three to five minutes. Remove the turtles from the molds and place them in cool water until they have cooled completely. Twisting the lure to remove it from the mold can cause the lure to tear or fail. Pull the lure straight out of the mold as soon as the plastic composition becomes solid. Let the turtles dry before you store them in plastic bags. Apply a few drops of oil to the low density plastic turtle lures to prevent them from sticking together in the bag and to keep them from drying out. One should work quickly when the low density plastic is hot as it will cool quickly and become too thick to pour. Add fluorescent plastic colors to the low density plastic before it is heated for best results.

The material you will use to make soft plastic fishing lures must be heated to about 325-350° F. Spilling or splashing hot plastic can cause serious burns to you and your helpers, so it is important to wear safety glasses or a face mask to shield against hot plastic spatters. Moreover, one should wear gloves, leather shoes and long sleeve shirt and pants to protect against burns and spatters. Also, one should never let water or moisture come in contact with heated soft plastic because moisture will turn to steam when it contacts hot plastic and cause splattering.

Once made, the red-eared slider turtle lure must be jigged with the proper hook placement, which is downwardly, upwardly or to the sides of the turtle body or turtle head. Multiple hooks can also be hung from various locations on the lure body. Double barbed hooks may also be used.

There are three main plastic rigs that can be used with the turtle lure: Texas rig, Carolina rig and weightless rig. A Texas rig involves threading a bullet-shaped sinker on the line above the hook, then tying the hook to the line. Thread the tip of the turtle lure onto the hook so that the hook point protrudes about ¼ of an inch down the turtle. Then pull the turtle tip up the hook until it is at the top of the hook. Then rotate the hook 180 degrees and impale the hook point into the turtle. The hook point should not protrude through the turtle.

The Carolina rig involves sliding a cone-shaped sinker and one to three beads onto the line, then tying a swivel on the end of the line. A leader should be tied to the other end of the swivel, and a hook tied at the end of the leader. Hook the turtle lure as you would a Texas-rigged turtle lure.

The third rigging option is to use no weight and just use the lure on its own. This is particularly effective in shallow areas, under docks, and around emergent vegetation. The Texas rig is effective around heavy cover, especially in deeper water, while the Carolina rig excels at locating bass scattered on clean bottoms.

When jigged, the turtle lures must be used with the right equipment. Most anglers choose bait casting reels and rods. The reels should be spooled with 10- to 20-1b. line, and the rods should be medium-heavy or heavy action and 6.5 to 7 feet long. Sensitive fishing rods are critical to successful plastic turtle lure fishing, since bass rarely hit a turtle lure hard. Instead, the hit is often little more than a tick, tap or the feeling of something different. It also pays to watch where your line enters the water, since sometimes the only evidence of a hit is your line jumping slightly or moving sideways.

Low density plastic lures are buoyant and float up to, or near the surface of a river, pond, or streams. In this manner, the lure can be retrieved through the water so it mimics a bait fish or bait turtle. Some of the most popular methods for rigging them are Texas rigs and on jig heads. Anglers like plastic lures because they can be fished in water of any depth and will attract any size bass that swims. The weight on the line can hit the bottom of the body of water, but the low density lure will float up and down like a turtle swimming around or trying to reach the water surface.

One possible use for the present invention is as follows. Rig your plastic turtle lures. If you have two fishing rods, tie a jig head onto one and a Texas rig onto the other. The best jig heads for fishing with plastic turtle lures weigh from ⅛ to ½ of an ounce and are shaped like mushrooms. But ball-shaped jig heads work, too. Slide the turtle lure onto the jig so the top of the turtle lure fits snugly against the jig head. To make a Texas rig, slide a cone-shaped sinker onto your line, then tie on a long-shanked hook. Thread the top of the turtle lure onto the hook so the hook protrudes about ⅛ of an inch down from the top of the turtle lure. Run the turtle lure up the shank of the hook so the top of the turtle lure is at the top of the hook. Turn the hook 180 degrees, and bury the point of it into the turtle lure to make the rig weedless.

One should also decide where you want to fish. Plastic turtle lures are most productive around aquatic vegetation and other cover that holds bass. A Texas-rigged plastic turtle lure will keep you from snagging in even the heaviest cover, while a turtle lure fished on a jig head is more useful where cover is sparse, since the hook is exposed. Plastic turtle lures fished on jig heads are particularly effective around drop-offs and other places where there are changes in water depth.

Cast the plastic turtle lure into the water and let it sink to the bottom. Reel in any slack line, then lift your rod tip to about the 12 o'clock position. If you feel any resistance, set the hook. Otherwise, lower your rod tip to the 9 o'clock position, reeling line in as you do so. Stop reeling when your rod is in the 9 o'clock position, then slowly raise your rod back to 12 o'clock. Repeat this process until your lure is back to the boat.

Vary the speed of your retrieval. Sometimes bass like a plastic turtle lure that moves quickly, other times they will not hit it unless it is sitting motionless on the bottom. Experiment with different retrievals until you catch a few bass, then use that retrieval until the fish quit biting. If the bass are feeding off the bottom, cast your turtle lure out and retrieve it without letting it hit the bottom.

Try different areas. Bass like to hide in the shade of boat docks. Cast your plastic turtle lure close to the boat docks, and get underneath them if you can. Emergent vegetation like lily pads and bulrushes also hold bass, and are good places to fish with Texas-rigged plastic turtle lures.

FIG. 3 illustrates a bottom view illustrating an embodiment of the red-eared slider fishing lure (301). The red-eared slider fishing lure (301) has a lure body (310). The lure body (310) has a top portion that resembles the upper side of a turtle shell, a bottom portion (313) that resembles the lower side of a turtle shell, a front portion, a rear portion, a left side and a right side. In the present invention, the lure has a high density plastic construction and low buoyancy to allow the lure to occupy deep water to bottom of water body areas.

Red-eared slider fishing lure (301) also has a font appendage (320) that resembles the head of a turtle, a left front appendage (332) that resembles the left front leg and foot of a turtle, a right front appendage (334) that resembles the right front leg and foot of a turtle, a rear appendage (340) that resembles the tail of a turtle, a left rear appendage (336) that resembles the left rear leg and foot of a turtle, and a right rear appendage (338) that resembles the right rear leg and foot of a turtle.

One embodiment of the red-eared slider fishing lure (301) has front appendage (320) integral to lure body (310) and extending out from the front portion of the lure body between the left and right sides, left front appendage (332) integral to lure body (310) and extending out from the front portion of the lure body along the left side of the lure body, right front appendage (334) integral to lure body (310) and extending out from the front portion of said lure body along the right side of the lure body, rear appendage (340) integral to lure body (310) and extending out from the rear portion of said lure body between the left and right sides, left rear appendage (336) integral to lure body (310) and extending out from the rear portion of said lure body along the left side of the lure body, and right rear appendage (338) integral to lure body (310) and extending out from the rear portion of said lure body along the right side of the lure body. The appendages are vertically located around the intersection of the top portion and the bottom portion (313) of lure body (310).

Another embodiment of the red-eared slider fishing lure (301) has front appendage (320) secured to said front portion of said lure body between the left and right sides, left front appendage (332) secured to said front portion of said lure body along the left side of the lure body, right front appendage (334) secured to said front portion of said lure body along the right side of the lure body, rear appendage (340) secured to said rear portion of said lure body between the left and right sides, left rear appendage (336) secured to said rear portion of said lure body along the left side of the lure body, and right rear appendage (338) secured to said rear portion of said lure body along the right side of the lure body. The appendages are vertically located around the intersection of the top portion and the bottom portion (313).

Lure body (310) further comprises a hook embedded within. The hook has a hook eye, a hook shaft, and a hook barb (370). Hook eye extends out of lure body (310) near the head appendage (320). This location for the hook eye is preferable as it allows the fishing lure to move in a forward motion when the fishing line is pulled. Hook barb (370) extends out of the left side of lure body (310). Preferably the hook barb (370) extends out and then forward as illustrated because the fish will most likely eat the lure from behind, but may extend out and up, down, back or at an angle. Hook barb (370) may also extend out of the right side, top portion, bottom portion, front portion, or back portion of the lure body.

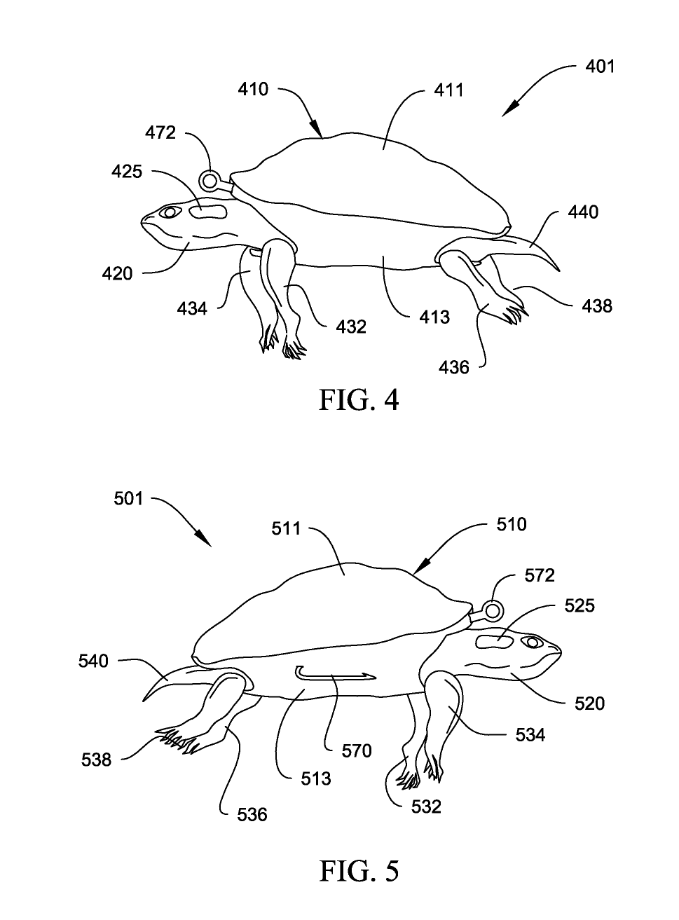

FIG. 4 illustrates a left side view illustrating an embodiment of the red-eared slider fishing lure (401). The red-eared slider fishing lure (401) has a lure body (410). The lure body (410) has a top portion (411) that resembles the upper side of a turtle shell, a bottom portion (413) that resembles the lower side of a turtle shell, a front portion, a rear portion, a left side and a right side. In the present invention, the lure has a high density plastic construction and low buoyancy to allow the lure to occupy deep water to bottom of water body areas.

Red-eared slider fishing lure (401) also has a font appendage (420) that resembles the head of a turtle, a left front appendage (432) that resembles the left front leg and foot of a turtle, a right front appendage that resembles the right front leg and foot of a turtle, a rear appendage (440) that resembles the tail of a turtle, a left rear appendage (436) that resembles the left rear leg and foot of a turtle, and a right rear appendage that resembles the right rear leg and foot of a turtle.

One embodiment of the red-eared slider fishing lure (401) has front appendage (420) integral to lure body (410) and extending out from the front portion of the lure body between the left and right sides, left front appendage (432) integral to lure body (410) and extending out from the front portion of the lure body along the left side of the lure body, right front appendage integral to lure body (410) and extending out from the front portion of said lure body along the right side of the lure body, rear appendage (440) integral to lure body (410) and extending out from the rear portion of said lure body between the left and right sides, left rear appendage (436) integral to lure body (410) and extending out from the rear portion of said lure body along the left side of the lure body, and right rear appendage integral to lure body (410) and extending out from the rear portion of said lure body along the right side of the lure body. The appendages are vertically located around the intersection of the top portion (411) and the bottom portion (413) of lure body (410).

Another embodiment of the red-eared slider fishing lure (401) has front appendage (420) secured to said front portion of said lure body between the left and right sides, left front appendage (432) secured to said front portion of said lure body along the left side of the lure body, right front appendage secured to said front portion of said lure body along the right side of the lure body, rear appendage (440) secured to said rear portion of said lure body between the left and right sides, left rear appendage (436) secured to said rear portion of said lure body along the left side of the lure body, and right rear appendage secured to said rear portion of said lure body along the right side of the lure body. The appendages are vertically located around the intersection of the top portion (411) and the bottom portion (413).

Lure body (410) further comprises a hook embedded within. The hook has a hook eye (472), a hook shaft, and a hook barb (470). Hook eye (472) extends out of lure body (410) near the head appendage (420). This location for the hook eye (472) is preferable as it allows the fishing lure to move in a forward motion when the fishing line is pulled. Hook barb (470) extends out of the left side of lure body (410). Preferably the hook barb (470) extends out and then forward as illustrated because the fish will most likely eat the lure from behind, but may extend out and up, down, back or at an angle. Hook barb (470) may also extend out of the right side, top portion, bottom portion, front portion, or back portion of the lure body.

FIG. 5 illustrates a right side view illustrating an embodiment of the red-eared slider fishing lure (501). The red-eared slider fishing lure (501) has a lure body (510). The lure body (510) has a top portion (511) that resembles the upper side of a turtle shell, a bottom portion (513) that resembles the lower side of a turtle shell, a front portion, a rear portion, a left side and a right side. In the present invention, the lure has a high density plastic construction and low buoyancy to allow the lure to occupy deep water to bottom of water body areas.

Red-eared slider fishing lure (501) also has a font appendage (520) that resembles the head of a turtle, a left front appendage that resembles the left front leg and foot of a turtle, a right front appendage (534) that resembles the right front leg and foot of a turtle, a rear appendage (540) that resembles the tail of a turtle, a left rear appendage that resembles the left rear leg and foot of a turtle, and a right rear appendage (538) that resembles the right rear leg and foot of a turtle.

One embodiment of the red-eared slider fishing lure (501) has front appendage (520) integral to lure body (510) and extending out from the front portion of the lure body between the left and right sides, left front appendage integral to lure body (510) and extending out from the front portion of the lure body along the left side of the lure body, right front appendage (534) integral to lure body (510) and extending out from the front portion of said lure body along the right side of the lure body, rear appendage (540) integral to lure body (510) and extending out from the rear portion of said lure body between the left and right sides, left rear appendage integral to lure body (510) and extending out from the rear portion of said lure body along the left side of the lure body, and right rear appendage (538) integral to lure body (510) and extending out from the rear portion of said lure body along the right side of the lure body. The appendages are vertically located around the intersection of the top portion (511) and the bottom portion (513) of lure body (510).

Another embodiment of the red-eared slider fishing lure (501) has front appendage (520) secured to said front portion of said lure body between the left and right sides, left front appendage secured to said front portion of said lure body along the left side of the lure body, right front appendage (534) secured to said front portion of said lure body along the right side of the lure body, rear appendage (540) secured to said rear portion of said lure body between the left and right sides, left rear appendage secured to said rear portion of said lure body along the left side of the lure body, and right rear appendage (538) secured to said rear portion of said lure body along the right side of the lure body. The appendages are vertically located around the intersection of the top portion (511) and the bottom portion (513).

Lure body (510) further comprises a hook embedded within. The hook has a hook eye (572), a hook shaft, and a hook barb. Hook eye (572) extends out of lure body (510) near the head appendage (520). This location for the hook eye (572) is preferable as it allows the fishing lure to move in a forward motion when the fishing line is pulled. Hook barb extends out of the left side of lure body (510). Preferably the hook barb extends out and then forward as illustrated because the fish will most likely eat the lure from behind, but may extend out and up, down, back or at an angle. Hook barb (570) may also extend out of the right side, top portion, bottom portion, front portion, or back portion of the lure body.

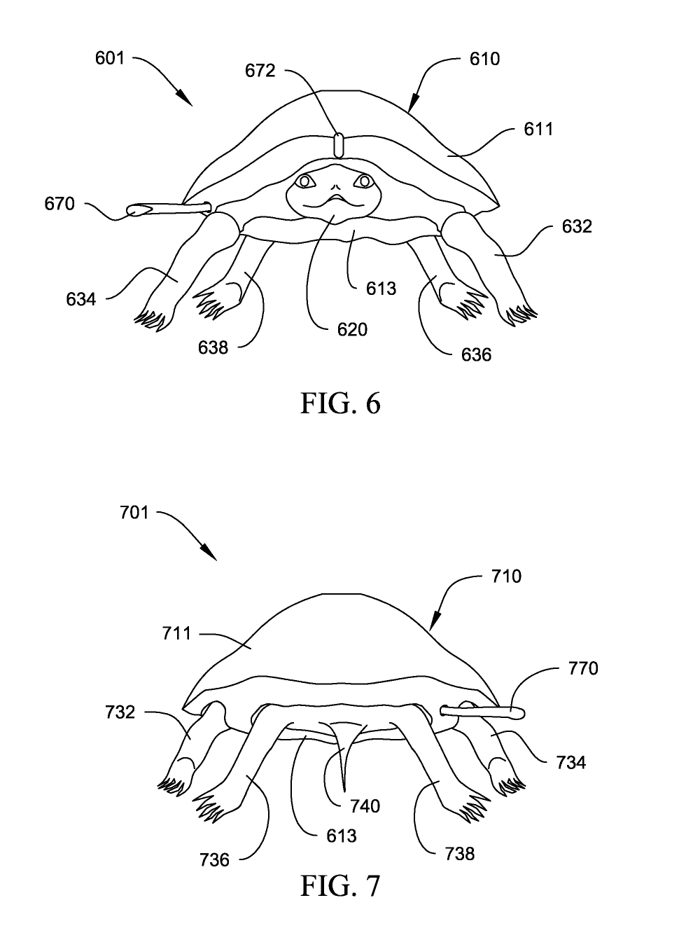

FIG. 6 illustrates a front view illustrating an embodiment of the red-eared slider fishing lure (601). The red-eared slider fishing lure (601) has a lure body (610). The lure body (610) has a top portion (611) that resembles the upper side of a turtle shell, a bottom portion (613) that resembles the lower side of a turtle shell, a front portion, a rear portion, a left side and a right side. In the present invention, the lure has a high density plastic construction and low buoyancy to allow the lure to occupy deep water to bottom of water body areas.

Red-eared slider fishing lure (601) also has a font appendage (620) that resembles the head of a turtle, a left front appendage (632) that resembles the left front leg and foot of a turtle, a right front appendage (634) that resembles the right front leg and foot of a turtle, a rear appendage that resembles the tail of a turtle, a left rear appendage that resembles the left rear leg and foot of a turtle, and a right rear appendage that resembles the right rear leg and foot of a turtle.

One embodiment of the red-eared slider fishing lure (601) has front appendage (620) integral to lure body (610) and extending out from the front portion of the lure body between the left and right sides, left front appendage (632) integral to lure body (610) and extending out from the front portion of the lure body along the left side of the lure body, right front appendage (634) integral to lure body (610) and extending out from the front portion of said lure body along the right side of the lure body, rear appendage integral to lure body (610) and extending out from the rear portion of said lure body between the left and right sides, left rear appendage integral to lure body (610) and extending out from the rear portion of said lure body along the left side of the lure body, and right rear appendage integral to lure body (610) and extending out from the rear portion of said lure body along the right side of the lure body. The appendages are vertically located around the intersection of the top portion (611) and the bottom portion (613) of lure body (610).

Another embodiment of the red-eared slider fishing lure (601) has front appendage (620) secured to said front portion of said lure body between the left and right sides, left front appendage (632) secured to said front portion of said lure body along the left side of the lure body, right front appendage (634) secured to said front portion of said lure body along the right side of the lure body, rear appendage secured to said rear portion of said lure body between the left and right sides, left rear appendage secured to said rear portion of said lure body along the left side of the lure body, and right rear appendage secured to said rear portion of said lure body along the right side of the lure body. The appendages are vertically located around the intersection of the top portion (611) and the bottom portion (613).

Lure body (610) further comprises a hook embedded within. The hook has a hook eye (672), a hook shaft, and a hook barb (670). Hook eye (672) extends out of lure body (610) near the head appendage (620). This location for the hook eye (672) is preferable as it allows the fishing lure to move in a forward motion when the fishing line is pulled. Hook barb (670) extends out of the left side of lure body (610). Preferably the hook barb (670) extends out and then forward as illustrated because the fish will most likely eat the lure from behind, but may extend out and up, down, back or at an angle. Hook barb (670) may also extend out of the right side, top portion, bottom portion, front portion, or back portion of the lure body.

FIG. 7 illustrates a back view illustrating an embodiment of the red-eared slider fishing lure (701). The red-eared slider fishing lure (701) has a lure body (710). The lure body (710) has a top portion (711) that resembles the upper side of a turtle shell, a bottom portion (713) that resembles the lower side of a turtle shell, a front portion, a rear portion, a left side and a right side. In the present invention, the lure has a high density plastic construction and low buoyancy to allow the lure to occupy deep water to bottom of water body areas.

Red-eared slider fishing lure (701) also has a font appendage that resembles the head of a turtle, a left front appendage that resembles the left front leg and foot of a turtle, a right front appendage that resembles the right front leg and foot of a turtle, a rear appendage (740) that resembles the tail of a turtle, a left rear appendage (736) that resembles the left rear leg and foot of a turtle, and a right rear appendage (738) that resembles the right rear leg and foot of a turtle.

One embodiment of the red-eared slider fishing lure (701) has front appendage integral to lure body (710) and extending out from the front portion of the lure body between the left and right sides, left front appendage integral to lure body (710) and extending out from the front portion of the lure body along the left side of the lure body, right front appendage integral to lure body (710) and extending out from the front portion of said lure body along the right side of the lure body, rear appendage (740) integral to lure body (710) and extending out from the rear portion of said lure body between the left and right sides, left rear appendage (736) integral to lure body (710) and extending out from the rear portion of said lure body along the left side of the lure body, and right rear appendage (738) integral to lure body (710) and extending out from the rear portion of said lure body along the right side of the lure body. The appendages are vertically located around the intersection of the top portion (711) and the bottom portion (713) of lure body (710).

Another embodiment of the red-eared slider fishing lure (701) has front appendage secured to said front portion of said lure body between the left and right sides, left front appendage secured to said front portion of said lure body along the left side of the lure body, right front appendage secured to said front portion of said lure body along the right side of the lure body, rear appendage (740) secured to said rear portion of said lure body between the left and right sides, left rear appendage (736) secured to said rear portion of said lure body along the left side of the lure body, and right rear appendage (738) secured to said rear portion of said lure body along the right side of the lure body. The appendages are vertically located around the intersection of the top portion (711) and the bottom portion (713).

Most preferably, the hook is embedded within the lure body with the hook eye and hook barb extending out of the lure body. The hook barb may extend out of the left side, right side, top portion, bottom portion, front portion, or back portion of the lure body. The hook eye preferably extends out of the front portion, left side or right side along the top portion of the lure body so that when the line is pulled, the fishing lure moves in a forward direction and remains in an upright or nearly upright position.

An alternate embodiment may have the fishing line threaded through the fishing lure and then tied to a fishing hook that is not embedded in the fishing lure. A less preferable alternate embodiment may have a hook without a hook eye embedded within the lure body. The fishing line would then be secured to a connector on the lure body or threaded through and tied around the lure body.

Fish tend to eat the turtles while the turtle is in the hatchling and early yearling phases of its life. Red ear slider hatchlings are roughly 1 inch (2.5 cm) in length. After the first year, a hatchling, now referred to as a yearling, should be around 2-3.5″ inches long. To have the red-eared slider fishing lure replicate the look and movement of the turtle hatchling or young yearling, preferably the length of the lure body from the forward apex of the front portion to the rearward apex of the rear portion is about 1½ inches. The red-eared slider fishing lure is about 2½ inches in length including the lure body and appendages.

Preferably the red-eared slider fishing lure is made of a polymer material embedded with anise and/or salt. The embedded anise and/or salt gives the red-eared slider fishing lure a specific fall rate that also affects the movement of the red-eared slider fishing lure giving it a seductive side-to-side action. The lure body or shell may be made of a higher density material or a harder material than the density or hardness of the appendages to enhance the illusion of the red-eared slider fishing lure as a real turtle.

A hatchling's shell, although not as hard as an adults (shells harden up at about a year), are typically firm to the touch. Additionally, by having the appendages made of a softer material, the material is more flimsy which increases the movement rate of the appendages compared to the lure body. The additional movement of the flimsy appendages allows the turtle red-eared slider fishing lure to appear as if it is swimming and thus more life-like. Other materials may be used, for example, plastics, foams, woods and metals.

The red-eared slider fishing lure is preferably made using an injection molding process. If using the same material for the lure body and appendages, injection molding allows the manufacturer to produce a red-eared slider fishing lure with the lure body and appendages integral with one another.

If using materials of different densities for the lure body and appendages, injection molding allows the manufacturer to first inject the lure body material into the mold and then inject the material of the appendages. The injection molding process can allow the manufacturer to fuse the appendages to the lure body at predetermined locations. Alternatively, the appendages can be formed in a separate injection molding process and secured to the formed lure body at predetermined locations.

The red-eared slider fishing lure may be designed to resemble various turtle species. For example, a red-eared slider fishing lure resembling a red ear slider turtle would have a bright red spot on the front appendage, which resembles the head of the red ear slider, behind each ear. The lure body and other appendages would also have the markings and shapes of the red ear slider's shell, legs and tail.

Further, the lure could resemble that of a male or female turtle. For example, the sex of red-eared sliders is determined by the incubation temperature during critical phases of the embryo's development. Only males are produced when eggs are incubated at temperatures of 22-27° C. (72-81° F.), whereas females develop at warmer temperatures. So depending on the climate of the area at the time, there may be more females or males at that given time. By providing both a male and a female red-eared slider fishing lure, the user can adjust to the current environment.

Although examples of the red ear slider have been disclosed, the red-eared slider fishing lure may be designed to resemble any type of turtle.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention.

Having described the invention, I claim:

1. A red-eared slider fishing lure, comprising:
a lure body having a top portion, a bottom portion, a front portion, a rear portion, a left side and a right side, said lure body made with a high density and low buoyance material;
a front head appendage integral to said lure body and extending out from the front portion of said lure body between the left and right sides, said front head appendage resembling the head of a turtle and having a first red quadrahedial coloration patch extending from the middle portion of the front head appendage to the rear portion of the front head appendage along the right side of the front head appendage and a second quadrahedial red coloration patch extending from the middle portion of the front head appendage to the rear portion of the front head appendage along the left side of the front head appendage;
a left front leg appendage integral to said lure body and extending out from the front portion of said lure body along the left side of the lure body, said left front leg appendage resembling the left front leg and foot of a turtle;
a right front leg appendage integral to said lure body and extending out from the front portion of said lure body along the right side of the lure body, said right front leg appendage resembling the right front leg and foot of a turtle;
a rear tail appendage integral to said lure body and extending out from the rear portion of said lure body between the left and right sides, said rear tail appendage resembling the tail of a turtle;
a left rear leg appendage integral to said lure body and extending out from the rear portion of said lure body along the left side of the lure body, said left rear leg appendage resembling the left rear leg and foot of a turtle;
a right rear leg appendage integral to said lure body and extending out from the rear portion of said lure body along the right side of the lure body, said right rear leg appendage resembling the right rear leg and foot of a turtle;
said front, left front, right front, rear, left rear and right rear appendages vertically located around an intersection of the top portion and the bottom portion of the lure body.

2. The red-eared slider fishing lure of claim 1, wherein said red-eared slider fishing lure has a hook extending downwardly from the lure body.

3. The red-eared slider fishing lure of claim 1, wherein said red-eared slider fishing lure has a hook extending upwardly from the lure body.

4. The red-eared slider fishing lure of claim 1, wherein said red-eared slider fishing lure has a hook extending from left side.

5. The red-eared slider fishing lure of claim 1, wherein said red-eared slider fishing lure has a hook extending from right side.

6. The red-eared slider fishing lure of claim 1, wherein said red-eared slider fishing lure has a hook extending from multiple locations along lure body.

7. The red-eared slider fishing lure of claim 1, wherein said lure body is made of a high density low buoying plastic.

8. The red-eared slider fishing lure of claim 7, wherein said front, left front, right front, rear, left rear and right rear appendages are made of a material with a lighter density than the lure body.

9. The red-eared slider fishing lure of claim 1, wherein the material used to make said front, left front, right front, rear, left rear and right rear appendages allows said appendages to move in a life-like manner while the red-eared slider fishing lure travels through the water.

10. A method of making a red-eared slider fishing lure, comprising the steps of:
providing a lure body having a top portion, a bottom portion, a front portion, a rear portion, a left side and a right side, said lure body made with a low density and high buoyance material;
providing a front head appendage integral to said lure body and extending out from the front portion of said lure body between the left and right sides, said front heat appendage resembling the head of a turtle; and having a first red quadrahedial coloration patch extending from the middle portion of the front head appendage to the rear portion of the front head appendage along the right side of the front head appendage and a second quadrahedial red coloration patch extending from the middle portion of the front head appendage to the rear portion of the front head appendage along the left side of the front head appendage;
providing a left front leg appendage integral to said lure body and extending out from the front portion of said lure body along the left side of the lure body, said left front leg appendage resembling the left front leg and foot of a turtle;
providing a right front leg appendage integral to said lure body and extending out from the front portion of said lure body along the right side of the lure body, said right leg front appendage resembling the right front leg and foot of a turtle;
providing a rear tail appendage integral to said lure body and extending out from the rear portion of said lure body between the left and right sides, said rear tail appendage resembling the tail of a turtle;
providing a left rear leg appendage integral to said lure body and extending out from the rear portion of said lure body along the left side of the lure body, said left rear leg appendage resembling the left rear leg and foot of a turtle;
providing a right rear leg appendage integral to said lure body and extending out from the rear portion of said lure body along the right side of the lure body, said right rear leg appendage resembling the right rear leg and foot of a turtle;
locating said front head, left front leg, right front leg, rear tail, left rear leg and right rear leg appendages around an intersection of the top portion and the bottom portion of the lure body.

11. The red-eared slider fishing lure of claim 10, wherein said red-eared slider fishing lure has a hook extending downwardly from the lure body.

12. The red-eared slider fishing lure of claim 10, wherein said red-eared slider fishing lure has a hook extending upwardly from the lure body.

13. The red-eared slider fishing lure of claim 10, wherein said red-eared slider fishing lure has a hook extending from left side.

14. The red-eared slider fishing lure of claim 10, wherein said red-eared slider fishing lure has a hook extending from right side.

15. The red-eared slider fishing lure of claim 10, wherein said red-eared slider fishing lure has a hook extending from multiple locations along lure body.

16. The red-eared slider fishing lure of claim 10, wherein said lure body is made of a high density low buoying plastic.

17. The red-eared slider fishing lure of claim 16, wherein said front, left front, right front, rear, left rear and right rear appendages are made of a material with a lighter density than the lure body.

18. The red-eared slider fishing lure of claim 10, wherein the material used to make said front, left front, right front, rear, left rear and right rear appendages allows said appendages to move in a life-like manner while the red-eared slider fishing lure travels through the water.

19. A red-eared slider fishing lure, comprising:
a lure body having a top portion, a bottom portion, a front portion, a rear portion, a left side and a right side, said lure body made with a low density and high buoyance material;
a front head appendage integral to said lure body and extending out from the front portion of said lure body between the left and right sides, said front head appendage resembling the head of a turtle and having a first red quadrahedial coloration patch extending from the middle portion of the front head appendage to the rear portion of the front head appendage along the right side of the front head appendage and a second quadrahedial red coloration patch extending from the middle portion of the front head appendage to the rear portion of the front head appendage along the left side of the front head appendage;
a left front leg appendage integral to said lure body and extending out from the front portion of said lure body along the left side of the lure body, said left front leg appendage resembling the left front leg and foot of a turtle;
a right front leg appendage integral to said lure body and extending out from the front portion of said lure body along the right side of the lure body, said right front leg appendage resembling the right front leg and foot of a turtle;
a rear tail appendage integral to said lure body and extending out from the rear portion of said lure body between the left and right sides, said rear tail appendage resembling the tail of a turtle;
a left rear leg appendage integral to said lure body and extending out from the rear portion of said lure body along the left side of the lure body, said left rear leg appendage resembling the left rear leg and foot of a turtle; and
a right rear leg appendage integral to said lure body and extending out from the rear portion of said lure body along the right side of the lure body, said right rear leg appendage resembling the right rear leg and foot of a turtle.

20. The red-eared slider fishing lure of claim 19, wherein said red-eared slider fishing lure has a hook extending downwardly from the lure body.

21. The red-eared slider fishing lure of claim 19, wherein said red-eared slider fishing lure has a hook extending upwardly from the lure body.

22. The red-eared slider fishing lure of claim 19, wherein said red-eared slider fishing lure has a hook extending from left side.

23. The red-eared slider fishing lure of claim 19, wherein said red-eared slider fishing lure has a hook extending from right side.

24. The red-eared slider fishing lure of claim 19, wherein said red-eared slider fishing lure has a hook extending from multiple locations along lure body.

25. The red-eared slider fishing lure of claim 19, wherein said lure body is made of a high density low buoying plastic.

26. The red-eared slider fishing lure of claim 25, wherein said front, left front, right front, rear, left rear and right rear appendages are made of a material with a lighter density than the lure body.

27. The red-eared slider fishing lure of claim 19, wherein the material used to make said front, left front, right front, rear, left rear and right rear appendages allows said appendages to move in a life-like manner while the red-eared slider fishing lure travels through the water.
